(19) United States
(12) Patent Application Publication
(10) Pub. No.: US 2015/0233602 A1
(43) Pub. Date: Aug. 20, 2015

(54) Weld pass-less boiler of cooking appliance

(71) Applicant: GINO CREATION CO., LTD., Taipei City (TW)

(72) Inventor: TSUNG-HSI LIU, Taipei City (TW)

(21) Appl. No.: 14/615,774

(22) Filed: Feb. 6, 2015

(30) Foreign Application Priority Data
Feb. 18, 2014 (TW) 103105367

(51) Int. Cl. F24H 1/06; F24H 1/18; A47J 31/54

(52) U.S. Cl. CPC F24H 1/06; A47J 31/54; F24H 1/181; F24H 1/185

(57) ABSTRACT

A boiler of cooking appliance is provided with cylindrical first and second half vessels releasably secured together; at least one screw type fastening assembly including a first seat, a joining member, at least one first sealing ring, a washer, and a nut; and at least one screw type fastening assembly including a second seat on an outer surface of the first or second half vessel, a ring, at least one second sealing ring, and washers put on second threaded fasteners. The ring is mounted on an inner surface of the second joining surface. A water heater is placed on the second seat with the second sealing ring squeezed therebetween. The water heater is inserted through the second central hole into the second half vessel. The second threaded fasteners are driven through the water heater into the ring to fasten them together.

### BACKGROUND OF THE INVENTION

1. Field of the Invention

The invention relates to weld pass-less boilers and more particularly to a weld pass-less, detachable boiler of a cooking appliance (e.g., coffeemaker or tea infuser).

2. Description of Related Art

A conventional cooking appliance (e.g., coffeemaker or tea infuser) includes a pump for pumping water from an external cold water reservoir to a boiler, a water heater (or heat exchanger) for heating the water to a predetermined temperature, and a piping assembly for flowing the hot water to a liquid distributor which in turn flows the hot water to a storage tank, the storage tank being capable of flowing the hot water to a chamber to mix with ground coffee. As a result, coffee is created.

Typically, the boiler of the cooking appliance (e.g., coffeemaker) is made of stainless steel and is manufactured by assembling vessels, a water heater, a heat exchanger, pipes, water level indicators, a safety valve, and a thermometer together. It is known that a boiler is a pressure vessel. Hot water in the boiler is subject to oxidation. Weld passes of a boiler are weaker in structural strength. Leak may occur at the weld passes due to thermal expansion. Further, fouling may form at the weld passes. Fouling may cause further oxidation and erosion and thus is detriment to the safety of the cooking appliance.

Broadly speaking, a water heater is a kind of a cooking appliance. The water heater is used to heat cold water to hot water and/or steam. For example, the hot water may be poured into a container to adjust concentration of the drink, heat the drink, etc. Fouling can form quickly when the supply of hot water and/or steam is great. The weld passes in the stainless boiler may quickly cause erosion and even leak if alkalinity greatly accumulates in the boiler due to insufficient treatment of soft water.

Thus, the need for improvement still exists.

### SUMMARY OF THE INVENTION

It is therefore one object of the invention to provide a weld pass-less boiler of a cooking appliance which is manufactured by assembling vessels, a water heater, a heat exchanger, pipes, and other indicators and safety devices. The assembly is done without welding and thus no weld passes are generated. Therefore, leak and fouling experienced by the conventional boiler of the cooking appliance are eliminated.

For achieving above an other objects of the invention, there is provided a weld pass-less boiler of a cooking appliance comprising a cylindrical first half vessel including a first annular member on a bottom, and a plurality of first holes through the first annular member; a cylindrical second half vessel including a second annular member on a top, and a plurality of second holes through the second annular member; a plurality of first threaded fasteners driven through the first holes and the second holes to fasten the first half vessel and the second half vessel together; at least one screw type fastening assembly each including a first seat, a joining member, at least one first sealing ring, a washer, and a nut wherein the first seat includes a first joining surface and a first central hole, the joining member includes a urging portion and a threaded shank passing through the first central hole until the urging portion is stopped by the first joining surface, the first sealing ring and the washer are sequentially put on an exposed portion of the threaded shank, and the nut is secured to the exposed portion of the threaded shank to tighten the first sealing ring, the washer, and the first joining surface together; and at least one screw type fastening assembly each including a second seat mounted on an outer surface of the first half vessel or the second half vessel, a ring member having a plurality of threaded holes, a plurality of second threaded fasteners, at least one second sealing ring, and a plurality of washers put on the second threaded fasteners wherein the second seat includes a second joining surface and a second central hole through the second joining surface, the second joining surface includes a plurality of first holes aligned with the threaded holes, the ring member is mounted on an inner surface of the second joining surface, a water heater or a heat exchanger is placed on the second joining surface with the second sealing ring squeezed therebetween, the water heater or the heat exchanger is inserted through the second central hole into the second half vessel, and the second threaded fasteners are driven through the water heater or the heat exchanger into the ring member to fasten them together.

Preferably, further comprising at least one third sealing ring mounted between the first half vessel and the second half vessel, a first flange having a plurality of holes disposed on the first annular member, and a second flange having a plurality of holes disposed on the second annular member, and wherein the plurality of first threaded fasteners are driven through the holes of the first flange, the first holes, the second holes, and the holes of the second flange to fasten the first flange, the first half vessel, the second half vessel, and the second flange together.

Preferably, the first flange includes a plurality of arc sections each having first and second ends, and the first end of one arc section is complimentarily engaged with the second end of an adjacent one of the arc sections.

Preferably, each of the first and second ends is inclined.

Preferably, each of the first and second ends is stepped.

Preferably, further comprising at least one first groove disposed on the joining member of the bolt and nut type fastening assembly urged against the first joining surface, and a food grade epoxy resin resistant to high temperature and being waterproof filled in the first groove.

Preferably, further comprising at least one second groove disposed on the ring member urged against the second joining surface, and a food grade epoxy resin resistant to high temperature and being waterproof filled in the second groove.

Preferably, each of the first and second joining surfaces is recessed.

Preferably, each of the first and second joining surfaces is curve to be complimentary to a curved surface of the first half vessel or the second half vessel.

Preferably, the first central hole has a non-circular section, further comprising a flange member having a non-circular section, the flange member being disposed on the first central hole for fastening the joining member.

### BRIEF DESCRIPTION OF THE DRAWINGS

The invention, as well as its many advantages, may be further understood by the following detailed description and drawings in which:

FIG. 1 is an exploded view of a weld pass-less boiler of a steam and hot water supplying device according to a first preferred embodiment of the invention;

FIG. 2 is an exploded view of the first half vessel to be assembled with fasteners shown in FIG. 1;

FIG. 3 is an exploded view of the second half vessel to be assembled with the water heater and other components shown in FIG. 1;

FIG. 4 is an exploded view of the first flange shown in FIG. 1;

FIG. 5 is a perspective view of the assembled weld pass-less boiler shown in FIG. 1;

FIG. 6 is a longitudinal sectional view of the weld pass-less boiler shown in FIG. 5;

FIG. 7 is a perspective view of a weld pass-less boiler of a coffeemaker according to a second preferred embodiment of the invention;

FIG. 8 is an exploded view of the heat exchanger to be assembled with the screw type fastening assembly and other fasteners;

FIG. 9 is a sectional view of the weld pass-less boiler shown in FIG. 7;

FIG. 10 is a sectional view of the first flange according to a second configuration;

FIG. 11 is a sectional view of a bolt and nut type fastening assembly according to a second configuration; and

FIG. 12 is a sectional view of a screw type fastening assembly according to a second configuration.

### DETAILED DESCRIPTION OF THE INVENTION

A weld pass-less boiler of a cooking appliance of the invention is manufactured by assembling vessels, a water heater, a heat exchanger, pipes, and other indicators and safety devices. The assembly is done without welding and thus no weld passes are generated. Therefore, leak and fouling experienced by the conventional boiler of the cooking appliance are eliminated.

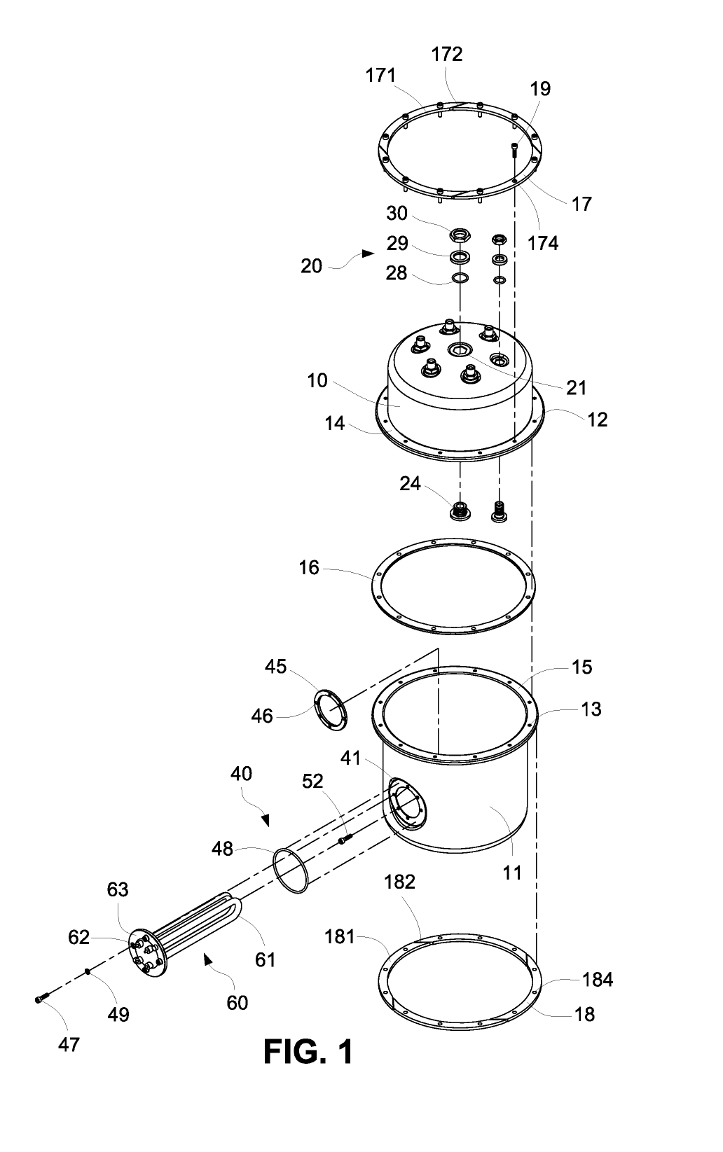

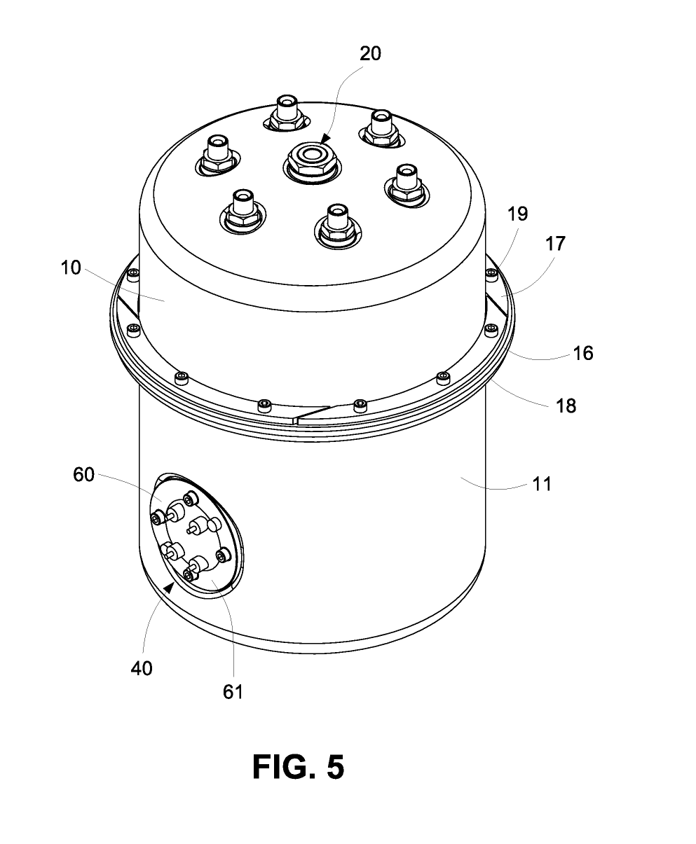

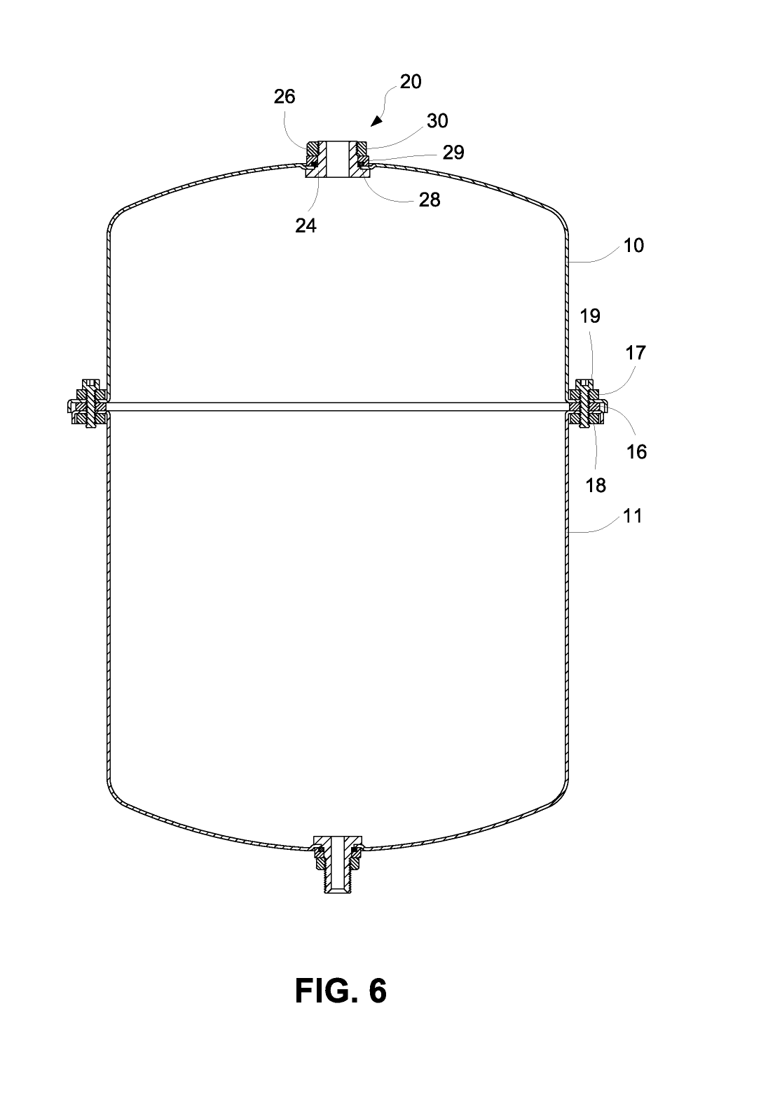

Referring to FIGS. 1 to 6, a weld pass-less boiler of a cooking appliance (e.g., steam and hot water supplying device) in accordance with a first preferred embodiment of the invention comprises the following components as discussed in detail below.

A cylindrical first half vessel 10 and a cylindrical second half vessel 11 are configured to assemble. The first half vessel 10 includes an annular member 14 on a bottom, and a plurality of equally spaced holes 12 formed through the annular member 14. The second half vessel 11 includes an annular member 15 on a top, and a plurality of equally spaced holes 13 formed through the annular member 15. A plurality of threaded fasteners 19 are driven through the holes 12, 13 to fasten the first half vessel 10 and the second half vessel 11 together. At least one screw type fastening assembly 20 is provided. At least one bolt and nut type fastening assembly 40 is provided to fasten a water heater 60 or a heat exchanger 70.

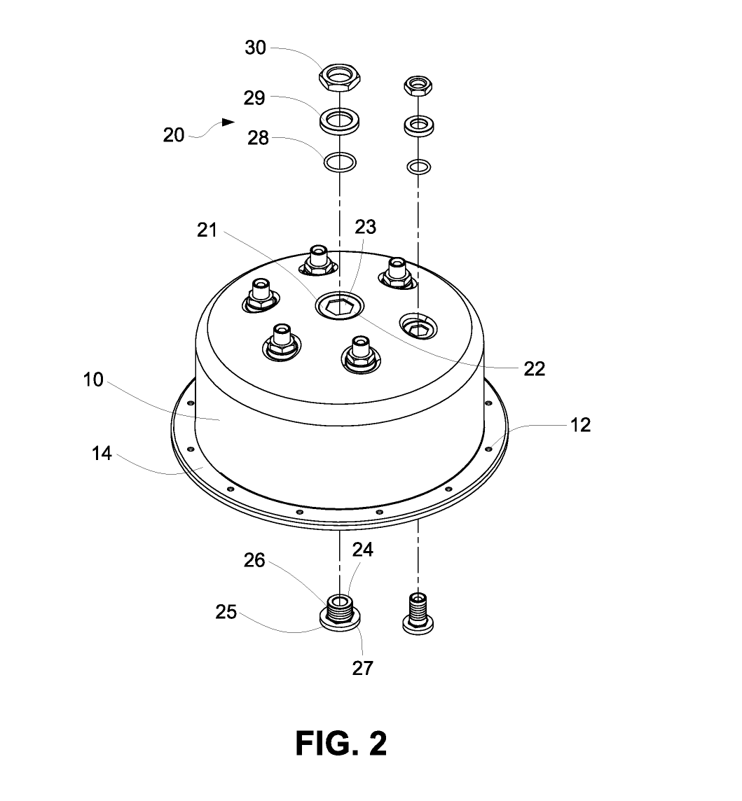

As shown in FIG. 2, the bolt and nut type fastening assembly 20 for assembling pipes and indicators is shown. The bolt and nut type fastening assembly 20 includes a first seat 21, a joining member 24, at least one first sealing ring 28, a washer 29, and a nut 30. The first seat 21 includes a first joining surface 22 and a central hole 23. The joining member 24 includes an annular urging portion 25 and a threaded shank 26 configured to pass through the central hole 23 until the urging portion 25 is stopped by the first joining surface 22. Next, the first sealing ring 28 and the washer 29 are sequentially put on the exposed portion of the threaded shank 26. Finally, the nut 30 is secured to the exposed portion of the threaded shank 26 to tighten the first sealing ring 28, the washer 29, and the first joining surface 22 together. One or more of pipes and indicators may be secured to the exposed portion of the threaded shank 26.

The first joining surface 22 is a recessed surface. Likewise, components including the joining member 24, the first sealing ring 28, and the washer 29, directly or indirectly contacting the first joining surface 22, have the same recessed surface.

The central hole 23 has a hexagonal section. A hexagonal flange 27 is put on a joining portion of the threaded shank 26 and the urging portion 25 of the joining member 24 so that the joining member 24 can be securely held in place. Above hexagonal components can be replaced by components of oval, recessed, etc. for fastening the joining member 24 without departing from the scope of the invention.

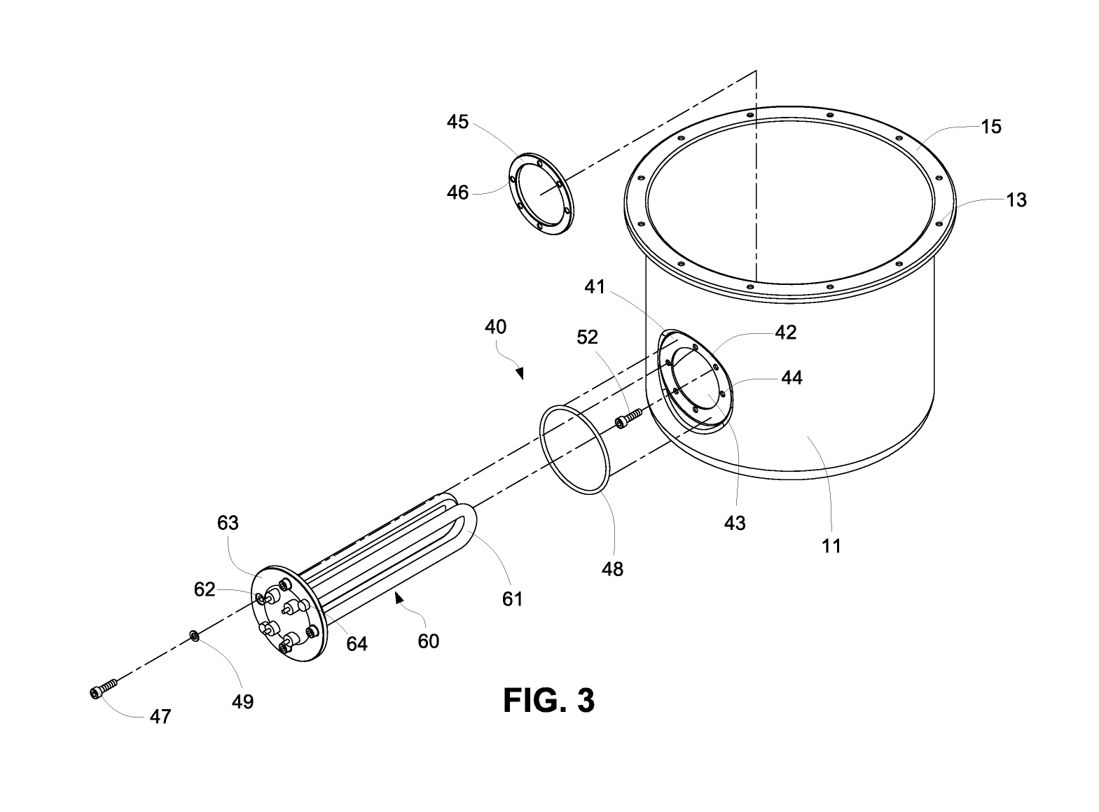

As shown in FIG. 3, the water heater 60 is secured to the second half vessel 11 by the screw type fastening assembly 40. The water heater 60 includes two heating pipes 61 and a disc shaped plate head 63 secured to the heating pipes 61 and having a plurality of holes 62. The screw type fastening assembly 40 includes a second seat 41 mounted on an outer surface of the second half vessel 11, a ring 45 having a plurality of threaded holes 46, a plurality of threaded fasteners 47, at least one second sealing ring 48, and a plurality of washers 49 put on the fasteners 47. The second seat 41 includes an annular second joining surface 42 and a central hole 43 through the second joining surface 42. A plurality of first holes 44 are formed through the second joining surface 42 and aligned with the threaded holes 46. The ring 45 is mounted on an inner surface of the second half vessel 11. The water heater 60 is placed on the second joining surface 42 with the second sealing ring 48 squeezed therebetween. The heating pipes 61 are inserted through the central hole 62 into the second half vessel 11. Finally, the fasteners 47 are driven through the holes 62, the holes 44, and the threaded holes 46 to fasten the water heater 60, the second half vessel 11, and the ring 45 together.

A plurality of threaded fasteners 52 are driven through the holes 44 into the threaded holes 46 to mount the ring 45 on the inner surface of the second joining surface 42 prior to mounting the water heater 60 onto the second half vessel 11. The ring 45 is secured to the second joining surface 42 even the water heater 60 is detached from the second half vessel 11 for replacement or repair. A plurality of cavities 64 are formed through the plate head 63 for receiving the heads of the threaded fasteners 52. After being fastened, the washers 49 put on the fasteners 47 can prevent water in the second half vessel 11 from leaking through the fasteners 47.

The second joining surface 42 is a recessed surface. Likewise, components including the ring 45, the second sealing ring 48, and the plate head 63 of the water heater 60, directly or indirectly contacting the second joining surface 42, have the same recessed surface.

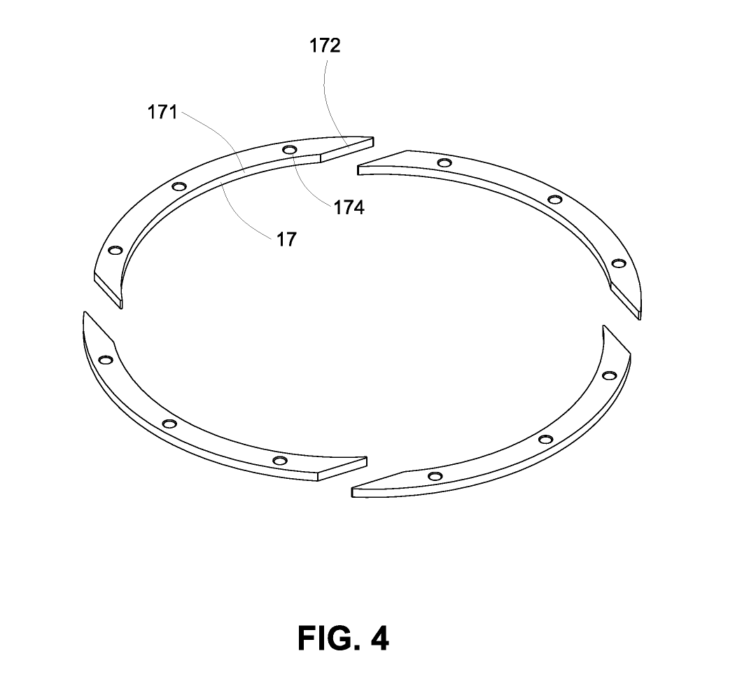

As shown in FIG. 1 specifically, at least one sealing ring 16 is mounted between the first half vessel 10 and the second half vessel 11. A first flange 17 having a plurality of equally spaced holes 174 is provided on the annular member 14 and a second flange 18 having a plurality of equally spaced holes 184 is provided on the annular member 15. A plurality of threaded fasteners 19 are driven through the holes 174, the holes 12, the holes 13, and the holes 184 to fasten the first flange 17, the first half vessel 10, the second half vessel 11, and the second flange 18 together. As shown in FIG. 4 specifically, the first flange 17 is comprised of a plurality of arc sections 171 each having two inclined ends 172. One inclined end 172 of one arc section 171 is complimentarily engaged with the other inclined end 172 of the adjacent other arc section 171.

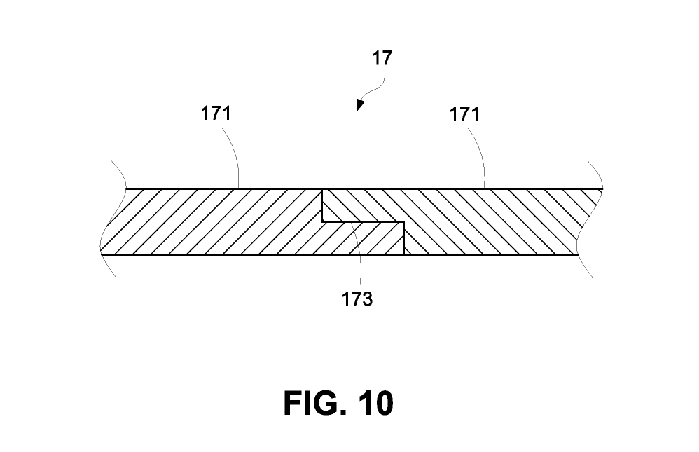

Referring to FIG. 10, in a second configuration of the first flange 17, each arc section 171 has two stepped ends 173 and one stepped end 173 of one arc section 171 is complimentarily engaged with the other stepped end 173 of the adjacent other arc section 171. The characteristics of the second flange 18 are substantially the same as that of the first flange 17.

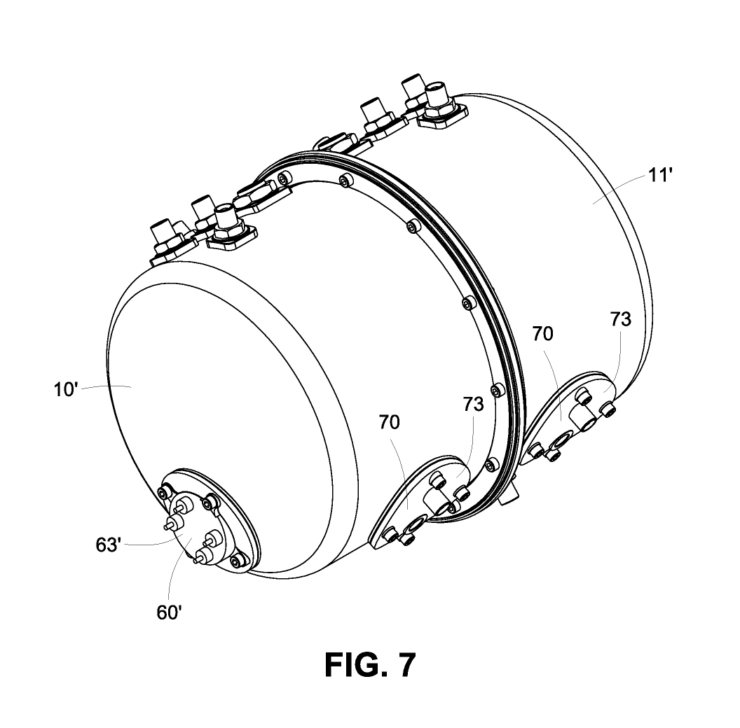

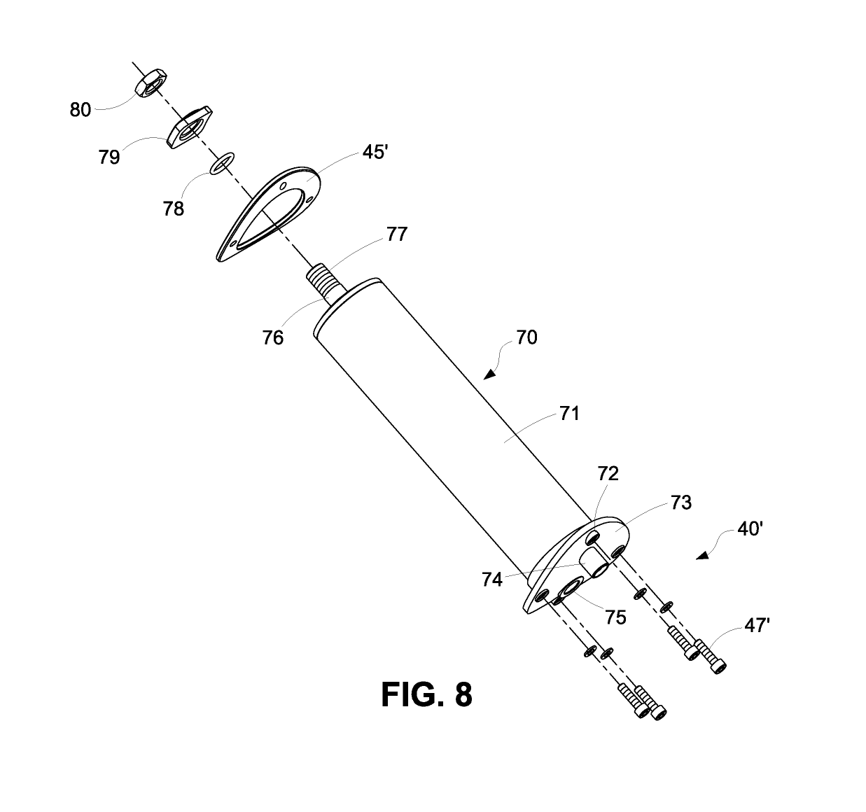

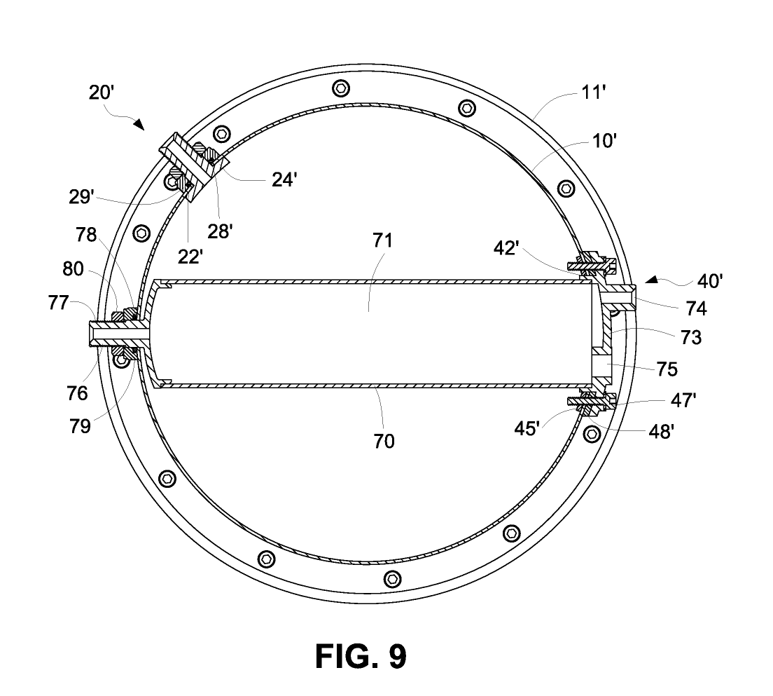

Referring to FIGS. 7 to 9, a weld pass-less boiler of a cooking appliance (e.g., coffeemaker or tea infuser) in accordance with a second preferred embodiment of the invention is shown. The characteristics of the second preferred embodiment are substantially the same as that of the first preferred embodiment except the following:

Two heat exchangers 70 and a water heater 60 are provided. The heat exchanger 70 includes a heat exchange pipe 71 and a disc-shaped plate head 73 having a plurality of holes 72. The mounting of the heat exchanger 70 onto the second half vessel 11′ is the same as that of the water heater 60. That is, a screw type fastening assembly 40′ is used to secure the heat exchanger 70 to the second half vessel 10′ or the second half vessel 11′. A first joining surface 22′ of a bolt and nut type fastening assembly 20′ is curve to be complimentary to the curved surface of the first half vessel 10′ or the second half vessel 11′. The first joining surface 22′ is a curved surface. Likewise, components including the joining member 24′, the first sealing ring 28′, and the washer 29′, directly or indirectly contacting the first joining surface 22, have the same curved surface. A second joining surface 42′ of a screw type fastening assembly 40′ is curve to be complimentary to the curved surface of the first half vessel 10′ or the second half vessel 11′. The second joining surface 42′ is a curved surface. Likewise, components including a ring 45′, a second sea sealing ring 48′, a plate head 63 of a heat exchanger 61′, and the plate head 73 of the heat exchanger 70, directly or indirectly contacting the second joining surface 42′, have the same curved surface.

The plate head 73 of the heat exchanger 70 is provided with an inlet 74 attached to an inlet pipe (not shown) and a port 75 attached to a feedback pipe (not shown). One end of the heat exchanger 70 opposite to the plate head 73 extends out of the boiler. An outlet 76 having external threads 77 provided at one end of the heat exchanger 70. An O-ring 78, a washer 79, and a nut 80 are secured to the threads 77 for purposes of fastening and leak prevention. The exposed portion of the threads 77 can be secured to an outlet pipe (not shown). A plurality of threaded fasteners 47′ are used to secure the plate head 73 to the heat exchanger 70 so that the heat exchanger 70 is prevented from rotation. Thus, means for preventing the heat exchanger 70 from rotation is not required to provide at the outlet 76. Above inlet pipe, feedback pipe, and outlet pipe are well known components of the espresso machine. Therefore, further description of the components is omitted herein for purposes of convenience only, and is not limited.

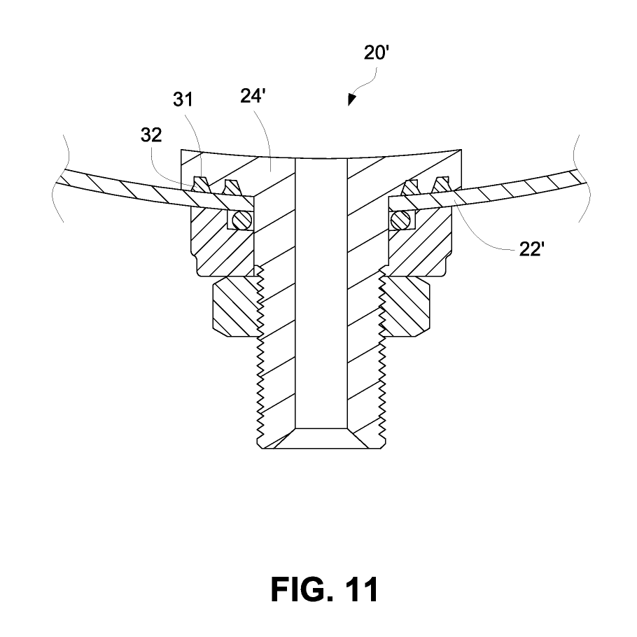

Referring to FIG. 11, at least one groove 31 is provided on the joining member 24 of the bolt and nut type fastening assembly 20′ urged against the first joining surface 22′. Food grade epoxy resin 32 resistant to high temperature and being waterproof is filled in the groove 31. After the epoxy resin 32 being cured, a joining surface of the joining member 24 and the first joining surface 22′ is made waterproof and fixed. Alternatively, the groove 31 is shaped a circle so that an O-ring may be received therein. The joining surface of the joining member 24 and the first joining surface 22′ is also made waterproof by the O-ring.

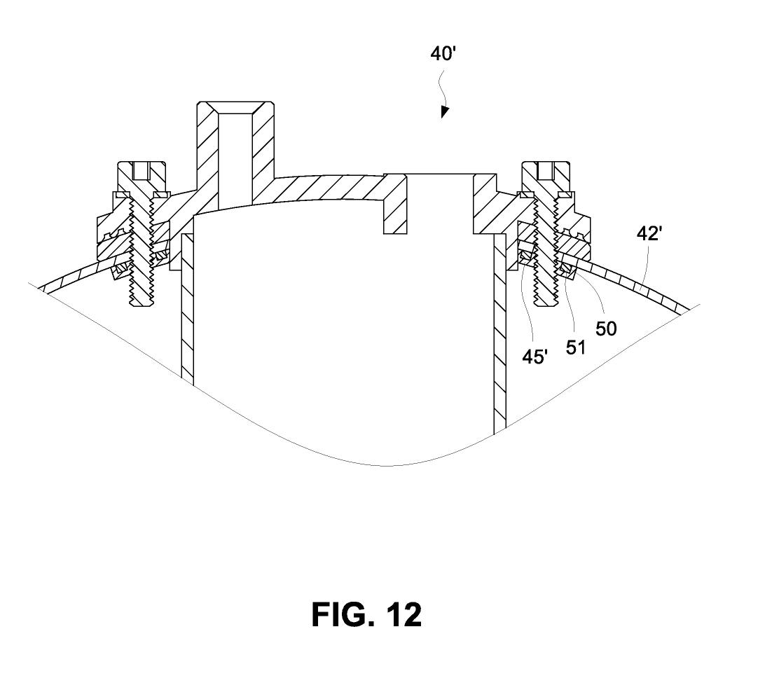

Referring to FIG. 12, at least one groove 50 is provided on a ring 45′ of a water heater3 40′ urged against the second joining surface 42′. Food grade epoxy resin 51 resistant to high temperature and being waterproof is filled in the groove 50. After the epoxy resin 51 being cured, a joining surface of the ring 45′ and the second joining surface 42′ is made waterproof and fixed.

The sealing ring of the invention can be O-ring, gasket, or other leak-proof means.

The epoxy resin of the invention is food grade adhesive.

It is envisaged by the invention that the weld pass-less boiler of a cooking appliance is manufactured by assembling vessels, a water heater, a heat exchanger, pipes, and other indicators and safety devices. The assembly is done without welding and thus no weld passes are generated. Therefore, leak and fouling experienced by the conventional boiler of the cooking appliance are eliminated.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A weld pass-less boiler of a cooking appliance comprising:
a cylindrical first half vessel including a first annular member on a bottom, and a plurality of first holes through the first annular member;
a cylindrical second half vessel including a second annular member on a top, and a plurality of second holes through the second annular member;
a plurality of first threaded fasteners driven through the first holes and the second holes to fasten the first half vessel and the second half vessel together;
at least one screw type fastening assembly each including a first seat, a joining member, at least one first sealing ring, a washer, and a nut wherein the first seat includes a first joining surface and a first central hole, the joining member includes a urging portion and a threaded shank passing through the first central hole until the urging portion is stopped by the first joining surface, the first sealing ring and the washer are sequentially put on an exposed portion of the threaded shank, and the nut is secured to the exposed portion of the threaded shank to tighten the first sealing ring, the washer, and the first joining surface together; and
at least one screw type fastening assembly each including a second seat mounted on an outer surface of the first half vessel or the second half vessel, a ring member having a plurality of threaded holes, a plurality of second threaded fasteners, at least one second sealing ring, and a plurality of washers put on the second threaded fasteners wherein the second seat includes a second joining surface and a second central hole through the second joining surface, the second joining surface includes a plurality of first holes aligned with the threaded holes, the ring member is mounted on an inner surface of the second joining surface, a water heater or a heat exchanger is placed on the second joining surface with the second sealing ring squeezed therebetween, the water heater or the heat exchanger is inserted through the second central hole into the second half vessel, and the second threaded fasteners are driven through the water heater or the heat exchanger into the ring member to fasten them together.

2. The weld pass-less boiler of a cooking appliance of claim 1, further comprising at least one third sealing ring mounted between the first half vessel and the second half vessel, a first flange having a plurality of holes disposed on the first annular member, and a second flange having a plurality of holes disposed on the second annular member, and wherein the plurality of first threaded fasteners are driven through the holes of the first flange, the first holes, the second holes, and the holes of the second flange to fasten the first flange, the first half vessel, the second half vessel, and the second flange together.

3. The weld pass-less boiler of a cooking appliance of claim 2, wherein the first flange includes a plurality of arc sections each having first and second ends, and the first end of one arc section is complimentarily engaged with the second end of an adjacent one of the arc sections.

4. The weld pass-less boiler of a cooking appliance of claim 3, wherein each of the first and second ends is inclined.

5. The weld pass-less boiler of a cooking appliance of claim 3, wherein each of the first and second ends is stepped.

6. The weld pass-less boiler of a cooking appliance of claim 1, further comprising at least one first groove disposed on the joining member of the bolt and nut type fastening assembly urged against the first joining surface, and a food grade epoxy resin resistant to high temperature and being waterproof filled in the first groove.

7. The weld pass-less boiler of a cooking appliance of claim 1, further comprising at least one second groove disposed on the ring member urged against the second joining surface, and a food grade epoxy resin resistant to high temperature and being waterproof filled in the second groove.

8. The weld pass-less boiler of a cooking appliance of claim 1, wherein each of the first and second joining surfaces is recessed.

9. The weld pass-less boiler of a cooking appliance of claim 1, wherein each of the first and second joining surfaces is curve to be complimentary to a curved surface of the first half vessel or the second half vessel.

10. The weld pass-less boiler of a cooking appliance of claim 1, wherein the first central hole has a non-circular section, further comprising a flange member having a non-circular section, the flange member being disposed on the first central hole for fastening the joining member.
